(19) United States
(12) Patent Application Publication
(10) Pub. No.: US 2026/0052101 A1
(43) Pub. Date: Feb. 19, 2026

(54) METHOD AND SYSTEM FOR OVERCOMING COMMUNICATION CHANNEL CONGESTION, DATA LOSS, AND DELAYS WITH FAST BIDIRECTIONAL COMMUNICATION USING HYBRID NETWORK AND AI OPTIMIZATION

(71) Applicant: Xinxin Shan, Surrey (CA)

(72) Inventor: Xinxin Shan, Surrey (CA)

(73) Assignee: LED Smart Inc, Surrey (CA)

(21) Appl. No.: 18/806,615

(22) Filed: Aug. 15, 2024

(51) Int. Cl. H04L 47/125; H04L 9/40; H04L 47/28; H04L 69/18

(52) U.S. Cl. CPC H04L 47/125; H04L 47/28; H04L 63/1416; H04L 69/18

(57) ABSTRACT

The invention provides a method and system for overcoming communication channel congestion, data loss, and delays through the use of a hybrid network system integrated with AI, energy harvesting, blockchain security, AR interfaces, and remote control capabilities. This system dynamically adapts to varying network conditions by switching between multiple communication protocols, optimizing energy use, securing data transmission, and allowing remote monitoring and control, ensuring efficient and reliable communication in various applications.

### CROSS-REFERENCE TO RELATED APPLICATIONS

US PATENT DOCUMENTS

| | | |
|---|---|---|
| 20220159019 A1 | May 2022 | Yang |
| 20200150638-A1 | May 2020 | Mourzine |
| 11,095,713-B2 | August 2021 | Speight |
| 10,225,710-B2 | March 2019 | Wang |
| 10,901,689-B1 | January 2021 | Trim |
| 20160197772-A1 | July 2016 | BRITT |

### OTHER PUBLICATION

Gilbert, J. M. et al, “Comparison of energy harvesting systems for wireless sensor networks”. Int. J. Autom. Comput. 5, 334-347 (2008). https://doi.org/10.1007/s11633-008-0334-2
Yi Yang, “Adaptive switching and routing protocol design and optimization in internet of things based on probabilistic models”, International Journal of Intelligent Networks, Volume 5, 2024, Pages 204-211
AIajlan, R. et al, “Cybersecurity for Blockchain-Based IoT Systems: A Review”, Appl. Sci. 2023, 13, 7432. https://doi.org/10.3390/app13137432

### BACKGROUND OF THE INVENTION

Traditional communication systems often face significant challenges, including congestion, data loss, and delays, particularly when relying on single or traditional protocols. These issues impede the efficient and reliable transmission of data, which is critical in applications such as military operations, IoT, and industrial automation. Existing solutions lack the capability to dynamically adapt to varying network conditions and effectively integrate multiple communication protocols.

### SUMMARY OF THE INVENTION

The present invention addresses these issues by providing a novel system and method that leverage a hybrid network system combined with AI, energy harvesting, blockchain security, AR interfaces, and remote control capabilities. This system is designed to overcome communication channel congestion, data loss, and delays, enabling fast, reliable, and secure bidirectional communication.

### BRIEF DESCRIPTION OF DRAWINGS

FIG. 1 System Overview Flowchart

FIG. 2 AI-Driven Adaptive Protocol Switching

FIG. 3 Energy Harvesting and Management

FIG. 4 Predictive Control via Machine Learning

FIG. 5 Security Management with Blockchain and AI

FIG. 6 Localized Edge Computing

FIG. 7 Context-Aware Communication Protocols

FIG. 8 AR Integration for Feedback and Control

FIG. 9 Remote Control System

### DETAILED DESCRIPTION OF THE INVENTION

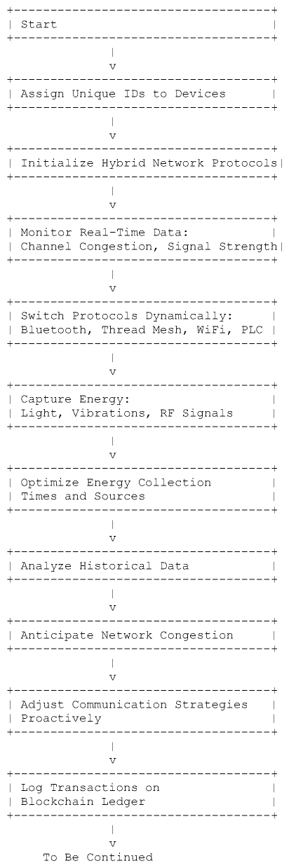

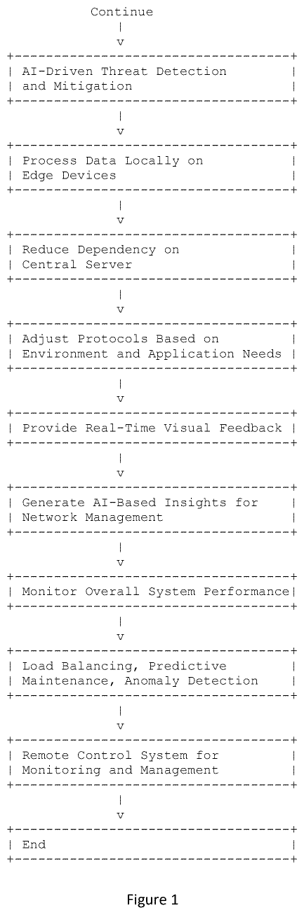

The system employs AI-driven algorithms to dynamically switch between various communication protocols, including Bluetooth, Bluetooth mesh, Thread mesh, WiFi, PLC (Power Line Communication), and other protocols. As illustrated in FIG. 1, the AI continuously monitors real-time or non-real-time data such as channel congestion, signal strength, and energy consumption to optimize the communication protocol in use. This adaptive approach ensures optimal performance, reduces latency, and addresses data congestion, loss, and delays inherent in single and traditional protocols.

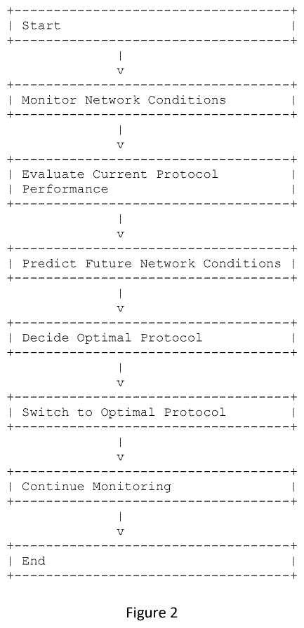

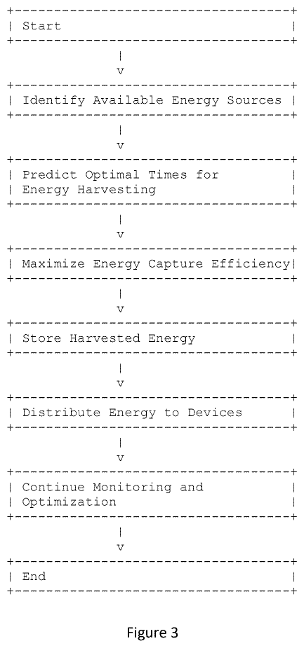

Devices within the system are equipped with energy harvesting capabilities, allowing them to capture energy from ambient sources such as light, vibrations, and RF signals. As illustrated in FIG. 3, the process begins with identifying available energy sources and predicting optimal times for energy harvesting. AI algorithms optimize this process by maximizing energy capture efficiency and storing the harvested energy. This approach, combined with the continuous monitoring and optimization depicted in FIG. 2, enhances the sustainability and operational lifespan of the devices.

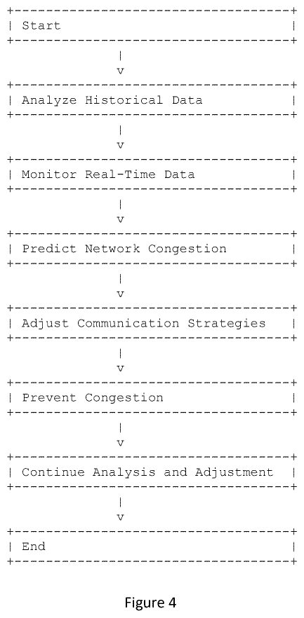

The system utilizes machine learning algorithms to predict device behavior and communication patterns. As illustrated in FIG. 4, the process begins with analyzing historical data and monitoring real-time data to predict network congestion. The AI then proactively adjusts communication strategies to prevent congestion, enhancing the system's efficiency and reliability. This predictive control mitigates issues of data loss and delays, ensuring smooth and uninterrupted communication.

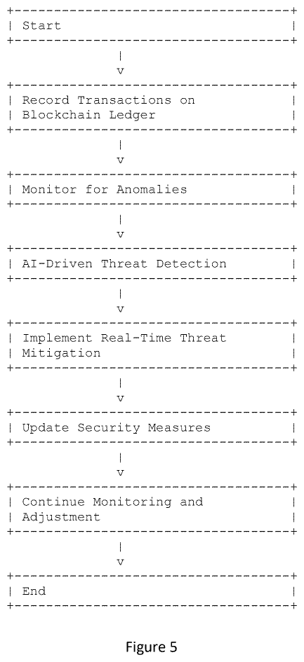

Blockchain technology is integrated to secure communication between devices. As illustrated in FIG. 5, each transaction or communication attempt is logged on a decentralized ledger, ensuring data integrity and security. Additionally, AI is employed to monitor for anomalies and detect potential security threats. Real-time threat mitigation is then implemented, followed by updates to security measures. This comprehensive approach enhances the system's security framework, ensuring robust protection against potential threats.

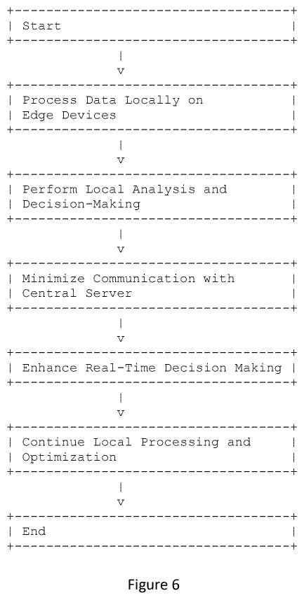

Edge computing capabilities are incorporated into the devices, enabling them to process data locally and reduce the need for constant communication with a central server. As illustrated in FIG. 6, data is processed on edge devices, allowing for local analysis and decision-making. This minimizes communication with the central server and enhances real-time decision-making. AI algorithms running on edge devices provide both real-time and non-real-time data analysis, further optimizing local processing. This localized approach enhances the system's speed and reliability, especially in environments with intermittent connectivity.

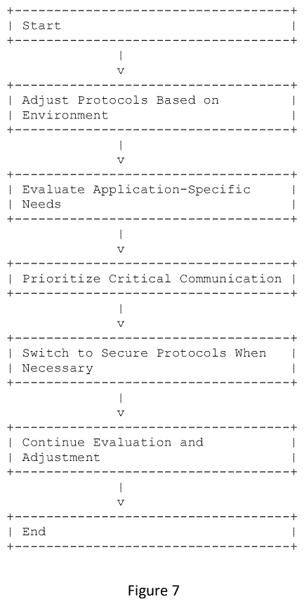

The system includes context-aware communication protocols that adjust based on the environment and specific application needs. As illustrated in FIG. 7, these protocols evaluate application-specific needs and prioritize critical communication. AI algorithms ensure that the system switches to more secure protocols when necessary, maintaining the reliability and promptness of mission-critical information transmission. Continuous evaluation and adjustment further enhance the system's adaptability and performance.

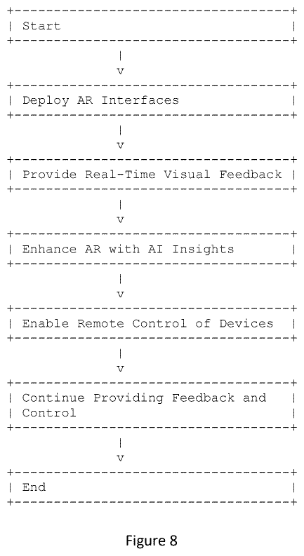

AR interfaces are integrated into the system to provide real-time visual feedback and control of devices. As illustrated in FIG. 8, these interfaces deploy AR to offer real-time visual feedback, enhanced with AI insights. AI algorithms provide intelligent recommendations based on data analysis, making it easier to manage complex networks of devices. This integration enables remote control of devices and ensures continuous feedback and control, enhancing the overall user experience.

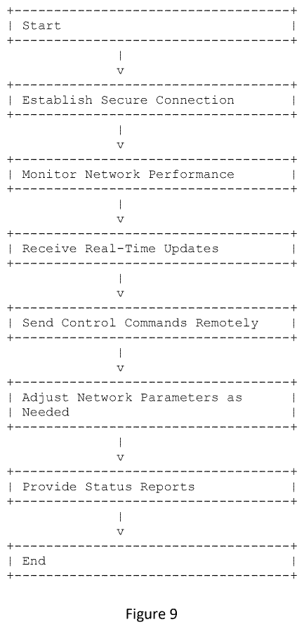

The invention includes a remote control system that allows users to monitor and manage the communication network from a distance. As illustrated in FIG. 9, this system establishes a secure connection and continuously monitors network performance. It provides real-time updates on network status and allows users to send control commands remotely. The system can adjust network parameters as needed and provides status reports, ensuring that users can effectively oversee and manage the network even from remote locations.

The AI system continuously monitors and optimizes overall performance by balancing the load across various communication channels. It also performs predictive maintenance on devices to ensure efficient operation and prevent potential failures. Additionally, the AI detects anomalies in real-time or non-real-time, proactively addressing any issues to maintain peak system efficiency and mitigate data congestion, loss, or delays.

1. A method for overcoming communication channel congestion, data loss, and delays, enabling fast bidirectional communication, comprising:
Assigning a unique ID to each device within a hybrid network system;
Dynamically switching between communication protocols based on real-time or non-real-time data;
Integrating energy harvesting mechanisms for capturing energy from ambient sources;
Implementing algorithms for predictive control to prevent network congestion;
Securing communication with blockchain technology and real-time or non-real-time threat detection;
Incorporating edge computing capabilities for localized data processing and decision-making;
Adapting context-aware communication protocols based on environmental and application-specific needs;
Continuously optimizing system performance with monitoring and adjustments;
Providing AR interfaces for real-time or non-real-time visual feedback and control of devices;
Providing a remote control system for monitoring and managing the network from a distance.

2. The method of claim 1, wherein the communication protocols include Bluetooth, Bluetooth mesh, Thread mesh, WiFi, and PLC.

3. The method of claim 1, wherein the energy harvesting mechanisms capture energy from light, vibrations, and RF signals.

4. The method of claim 1, wherein the blockchain technology logs each transaction or communication attempt on a decentralized ledger.

5. The method of claim 1, wherein the AI-driven threat detection and mitigation enhance security.

6. The method of claim 1 further comprising providing AR interfaces for real-time or non-real-time visual feedback and control of devices.

7. The method of claim 1 further comprising implementing a remote control system for monitoring and managing the communication network from a distance, utilizing secure communication protocols to provide real-time or non-real-time updates on network performance and device status.

8. The method of claim 1, wherein the remote control system allows users to adjust network parameters and control devices remotely to ensure optimal performance and reliability.

9. A method for overcoming communication channel congestion, data loss, and delays, enabling fast bidirectional communication, comprising:
Assigning a unique ID to each device within a hybrid network system;
Utilizing AI to dynamically switch between communication protocols based on real-time or non-real-time data, including analyzing and predicting network conditions, channel congestion, and signal strength;
Integrating energy harvesting mechanisms optimized by AI for capturing energy from ambient sources, including light, vibrations, and RF signals, and predicting optimal times for energy collection;
Implementing machine learning algorithms for predictive control to prevent network congestion by analyzing historical and real-time or non-real-time data to anticipate communication patterns and proactively adjust strategies;
Securing communication with blockchain technology and enhancing security with AI-driven real-time or non-real-time threat detection and mitigation, analyzing potential vulnerabilities, and adjusting security measures dynamically;
Incorporating edge computing capabilities with AI for localized data processing, enabling real-time or non-real-time decision-making and reducing the need for constant communication with a central server;
Adapting context-aware communication protocols with AI based on environmental and application-specific needs, prioritizing critical communication and switching to more secure protocols under specific conditions;
Continuously optimizing system performance with AI-driven monitoring and adjustments, including load balancing across communication channels, predictive maintenance of devices, and real-time or non-real-time anomaly detection;
Providing AR interfaces for real-time or non-real-time visual feedback and control of devices;
Implementing a remote control system for monitoring and managing the communication network.

10. The method of claim 9 further comprising providing AR interfaces for real-time or non-real-time visual feedback and control of devices.

11. The method of claim 9 further comprising implementing a remote control system for monitoring and managing the communication network from a distance, utilizing secure communication protocols to provide real-time or non-real-time updates on network performance and device status.

12. The method of claim 9, wherein the remote control system allows users to adjust network parameters and control devices remotely to ensure optimal performance and reliability.
